(19) United States
(12) Patent Application Publication
(10) Pub. No.: US 2018/0132469 A1
(43) Pub. Date: May 17, 2018

(54) SYSTEM, APPARATUS, AND METHOD FOR SUBTERRANEAN TERMITE CONTROL

(71) Applicants: Tony Nick Frudakis, Bradenton, FL (US); Oliver Petereit, Bradenton, FL (US)

(72) Inventors: Tony Nick Frudakis, Bradenton, FL (US); Oliver Petereit, Bradenton, FL (US)

(21) Appl. No.: 15/243,097

(22) Filed: Aug. 22, 2016

Related U.S. Application Data
(60) Provisional application No. 62/208,310, filed on Aug. 21, 2015.

(51) Int. Cl. A01M 1/20; A01M 1/02; A01M 1/22; A01M 1/24

(52) U.S. Cl. CPC A01M 1/2011; A01M 1/026; A01M 1/245; A01M 1/226; A01M 1/023

(57) ABSTRACT

An improved system, apparatus, and method for use in controlling subterranean termite populations are described. It is determined whether one or more of the sensor characteristics in one or more of the underground soil regions are indicative of a subterranean termite population exceeding a threshold. Based on the determining, a treatment need is identified for the one or more underground soil regions. The treatment need is executed at regions corresponding to the one or more underground soil regions.

### BACKGROUND

### Technical Field

The field of the invention relates to the control of subterranean termite populations, such as the control of subterranean termite populations, which are underground beneath lawns surrounding residences.

### Background Information

It has long been known that termites can enter into homes and other structures and cause serious damage. It has been reported that termites cause more damage to wood containing buildings in the United States than any other type of insect. Most of the termite damage in the United States is caused particularly by subterranean termites.

While termites, as wood-destroying insects, play an important beneficial role in the recycling and decomposition of vegetable matter (e.g. fallen trees), they have proven to be a nuisance in residential property. Such destruction is now to be known as a six billion dollar industry per year, with the average repair bill after detection of termite infestation of approximately seven thousand dollars per occurrence. According to these figures, insurance companies will not provide any coverage for termite infestation and/or damage. The damage combined by flood, fire, hail and storm is less than half of termite damage per year.

A termite colony can be considered to be an enormous amorphous organism. Like a giant amoeba, its foraging workers poke and explore in all directions from their termite nest in a continuous search for food and water.

Termites are insects in the order Isoptera. They are social insects that live in colonies and whose members have thirty different physical characteristics and perform different functions. Termites hatch from an egg and develop through gradual metamorphosis to one of four general adult forms. The four adult forms are: (a) the worker; (b) the soldier; (c) the secondary reproductives; and (d) the primary queen and king.

Workers make up the largest part of the colony. They construct and repair the termite nest, care for the eggs and growing population. In their constant search for food, foraging termites bite into anything softer than their hard teeth including, for example, leather, PVC pipe, and swimming pool liners.

Information related to sources of new food, threats to the colony, or damage to the nest are communicated from one termite to another by chemical odor (pheromone) communication, touch (tactile) communication, and vibrations produced by soldier termites banging their heads on the walls of the nest.

An ideal climate was created for termites when modern man developed homes and other buildings in termites' ancient homeland, the forest. In constructing homes, large numbers of huge trees were cut and removed.

The soldier termite serves to protect the termite colony from attack by termite predators, such as ants, which are the principal natural termite predator. The soldier termite is conspicuous by its enlarged head and mandibles.

Numerous secondary reproductives develop in mature termite colonies. Secondary reproductives lay eggs, but the eggs develop only into worker termites as long as the primary mother queen is alive and functioning. Collectively, the secondary reproductives can produce more eggs than the mother queen.

The primary queen and king are the winged reproductives that swarm from a mature colony, fly a short distance from the nest, shed their wings, and pair off to make a chamber and start a new termite colony in a suitable substrate, such as moist soil under a tree stump or cellulose debris. It takes several years for this primary queen and king to rear a colony that is large and mature enough to produce and send out winged colonizing swarmers.

A colony of subterranean termites has requirements of protection, moisture and food. The initial female (queen) and male (king) termite will select a site which usually includes moist, partially rotted wood in contact with the soil. After establishing the site, the pair will mate and the queen will begin laying eggs. Usually, only a few eggs are laid the first few months and the queen and king will care for the young termites until the young termites are mature.

Subterranean termites became attracted to moisture around home sites where lawns and ornamental plants were frequently watered, especially during dry spells. Attracted by the moisture near the foundation of the home, the foraging termites inevitably found scrap lumber, form lumber, and other cellulose debris left under and around the home by the home builder. Further foraging led the termites to the foundation wall of the home itself where numerous mortar breaks and cracks in the foundation wall provided easy access to the structure's wooden joists, framing and cellulose contents.

Older homes in communities are particularly vulnerable to termite attack since original ornamental plants surrounding the older home have usually died and been replaced, leaving old root systems behind. In addition, leaky hose bibs and water pipes are more common in older homes than newer homes. Also, improper drainage from roofs or at the downspout outlet often directs massive amounts of rainwater along the foundation of homes. These conditions are overwhelmingly powerful attractants for termites to the site.

The best time to protect man-made structures from termite damage is during the planning and construction of the structure. Proper site location, good foundation and building design, treatment of the soil under and around the foundation, and use of treated lumber coupled with periodic inspections will protect structures for many years.

Exceptionally effective protection for up to several decades was provided by the termiticide chlordane when it was used as a pretreatment in the soil under and around the foundation. However, cancellation of the registration of chlordane by the United States Environmental Protection Agency (EPA) has eliminated it as a tool for protection against termites. None of the new termiticides that have replaced chlordane possess chlordane's ability to diffuse through the soil and its long residual termiticide properties.

Even the best planned and constructed buildings come under termite attack. Termite workers are always foraging for new sources of food. Due to cracks in a building's construction material, faulty building design, will lead eventually to a subterranean termite infestation.

One conventional way of detecting subterranean termite infestation relies on manually checking termite “bait stations,” i.e. Sentricon, Termatrec, Advance Bait Stations, etc. These bait stations are typically spaced out approximately five feet apart in the ground, and checked manually by a trained termite technician (e.g. usually every two months). The hope is that the termites will, by chance, find a wooden stick (or something similarly inserted in the bait box) for evidence of termite infestation. At that point, a manual treatment usually done by a termite technician through a spray rig on a termite truck around the perimeter of the house either by a method of trench and treat and/or rodding, which is labor intensive and disruptive for the landscape.

The problems with this approach are many. The bait traps have to be manually set, which takes time. The technique is subject to a high type II (false negative) error rate, meaning that termites may be present but not detected. As noted, the method of detection involves placing a wood stick into the bait box and monitoring whether the stick has been eaten at some point later. How long the stick is left in the box, and what constitutes “eaten,” are subjectively and unsystematically determined without any type of standardization, and variations from test-to-test produce erratic, unreliable results. Also, placement and detection are manual, requiring significant labor costs. Not only do the traps have to be set, but they have to be checked on a regular basis by a termite technician in order to determine if live termites are present.

Other ways for termite control use contact-based (e.g. thermocouple) or non-contact-based (e.g. infrared imaging) techniques to detect heat for inferring termite infestation. Although these devices are powerful, they are not useful underground, and they are not useful for determining termite presence where termites live in the soil or where termite infestations originate from.

Another way of treating an identified termite infestation is to exchange the wooden stick for a termite bait cartridge containing a slow acting poison. Here, it is hoped that the termites will find their way back to the spot, eat from the cartridge, and bring it back to the main colony where the termites feed each other. Thus, the slow acting poison would be distributed throughout the food chain, which will result in the death of the queen who is the sole provider of new termite generations.

Subterranean termite forage randomly—which means they may never find the particular installed subterranean bait boxes—but still enter the premise.

### BRIEF DESCRIPTION OF THE DRAWINGS

FIGS. 1A-1B illustrate an exemplary device for insect control, in accordance with an embodiment of the present invention;

FIGS. 2-3 illustrate other exemplary devices for insect control, in accordance with alternative embodiments of the present invention;

FIGS. 4-5 show an exemplary deployment of the devices in a house or building; and

FIG. 6 is a block diagram depicting an exemplary client/server system which may be used by an exemplary web-enabled/networked embodiment of the present invention.

### OVERVIEW

Accordingly, an improved system, apparatus, and method for use in effectively and efficiently controlling subterranean termite populations are described.

In one method, sensor characteristics are monitored in a plurality of underground soil regions. Sensor characteristics are monitored in a plurality of underground soil regions. It is determined whether one or more of the sensor characteristics in one or more of the underground soil regions are indicative of a subterranean termite population exceeding a threshold. A treatment need is identified at the one or more underground soil regions based on the determining. The treatment need is executed at regions corresponding to the one or more underground soil regions.

The conditions may be wirelessly communicated (e.g. Wi-Fi) from the underground soil regions to a central controller. The monitoring of the sensor characteristics may involve monitoring the sensor characteristics at a plurality of termite sticks which are at least partially inserted in the ground, where the sensor characteristics are wirelessly communicated from the termite sticks to a central controller. The determining, the identifying, and the controlling may be performed at the central controller.

One or more other characteristics may be monitored as well. These other characteristics may be indicative of favorable or unfavorable treatment conditions. These other characteristics may involve a weather characteristic, which may include one of a temperature, a humidity, a wind speed, and an insolation characteristic. The executing of the treatment need may be delayed based on the determining of an unfavorable treatment condition.

Further, a system for use in controlling subterranean termite populations may be implemented. The system may comprise a plurality of termite sticks, a reservoir, and a central controller. Each termite stick may have attached at least one sensor for sensing a characteristic underground where the termite stick may be at least partially inserted. The reservoir may be configured to hold a termiticide and connect to a plurality of dispensers. The dispensers may be included or carried on the termite sticks. The central controller may be configured to receive data from the sensors, and to control release of the termiticide via one or more of the dispensers based on assessing the data. Instead of using the reservoir and termiticide, other alternative techniques may be employed as the treatment need for termite control.

The central controller may be configured to determine whether the data are indicative of a subterranean termite population exceeding a threshold, identify a treatment need based on the determining, and execute the treatment need in response to the identifying. The controller may be coupled to a first wireless transceiver, each termite stick may be coupled to a second wireless transceiver, and the second wireless transceiver may communicate, to the controller, wireless signals carrying the data.

Further, a device for use in controlling subterranean termite populations may also be implemented. The device comprises a stick, at least one sensor attached to the stick, and a wireless transceiver. The stick is configured to be inserted at least partially underground. The at least one sensor is configured to sense at least one sensor characteristic underground indicative of a subterranean termite population. The sensor is configured for sensing a sensor characteristic underground where the termite stick may be at least partially inserted. The wireless transceiver is configured to wirelessly communicate, to a controller, the at least one characteristic underground for identifying a treatment need. The wireless transceiver may be a Wi-Fi transceiver. In an embodiment, a dispenser may be carried on the stick and be configured to release a termiticide in response to a command from the controller received via the wireless transceiver.

In one preferred embodiment, a sensor or sensor circuit may comprise a conductor cord or strip having one or more conductors and/or a termite-gnawable and/or termite-edible material. Preferably, along with the entire sensor or sensor circuit, the conductor cord is for use in being disposed underground in the soil. A transmission line of the sensor circuit is characterized by the conductor cord as well as by any effecting surrounding elements (e.g. soil or earth, water, or air) in the soil. Here, the sensor or sensor circuit may further comprise a signal generator to produce signals in the conductor cord and a detector to detect changes in the signals. Detection of a subterranean termite population may be made by detecting a substantial or suitable change in the signals which vary based on or in accordance with a change in the value of a property of the transmission line. The property of the transmission line may be a dielectric property, a resistance or impedance property, or both (and/or any other suitable property or properties). The signals may vary based on changes in a transmission line characteristic of the transmission line.

### Embodiments/Description

Techniques of the present disclosure relate to automated subterranean termite (or other pest) population control, using a central controller that accumulates data relevant in making treatment decisions, and a plurality of devices distributed in an area and at least partially inserted in the soil, each providing data and dispensing a chemical (e.g. a termiticide) in response to the treatment decisions. The devices may be referred to as termite sticks, sensor sticks, probes, or rods.

The termite sticks, each having one or more sensors, may be inserted at least partially underground, spaced out around the perimeter of a residence in such a way that the sensor fields overlap. The termite stick may wirelessly report sensor characteristics being sensed to a central “smart technology” controller.

The sensed characteristics may be or include, for example, thermal heat or moisture level characteristics; seismic-type, vibrational, or acoustic characteristics indicative of air pockets or tunnels created by a subterranean termite population; or sound or acoustic levels produced by a subterranean termite population. The technique may involve other sensed characteristics, e.g. sensing for pH level, alkalinity, detection of minerals such as phosphorus, potassium, calcium, magnesium, sodium, sulfur, manganese, copper, zinc, etc.

The central “smart” controller will be coupled in its own wireless network (e.g. Wi-Fi network), with or without an extender for better coverage, and tied into an existing modem for Internet access. The controller commands the termite stick to dispense, once or in a series of multiple-scheduled dispensings, an appropriate amount of termiticide for protecting and eradicating the infestation, based on the termiticide label requirements. Again, other alternative techniques may be employed as the treatment need for termite control.

The termite sticks are at least partially embedded in the ground, with below-ground and above-ground portions. The dispensing portion may be underground and be connected to a reservoir or tank (e.g. a three-tank, pump and/or valve system). The three-tank system is also Wi-Fi-capable, and may include sensors for depletion rate. It will report back to the controller, which will alert the existing customer and/or the pest and termite control company via email or other electronic means. The controller receives data via the Internet from the National Weather Service, or other similar weather forecasts corresponding to the location (e.g. zip code) of the residence, and existing as well as forecast ambient conditions will be factored into the decision on when treatment will be applied via the termite stick.

The technique may involve use of a weather station above ground for measuring wind, shade, moisture, precipitation and line of sight above ground for proper cutting purposes of existing lawns.

Thus, a method, apparatus, and system for more efficiently controlling subterranean termites by enhancing the likelihood that they will be positively identified is provided, by monitoring sensor characteristics underground, to dispense appropriate amounts of termiticide through an underground dispense irrigation system.

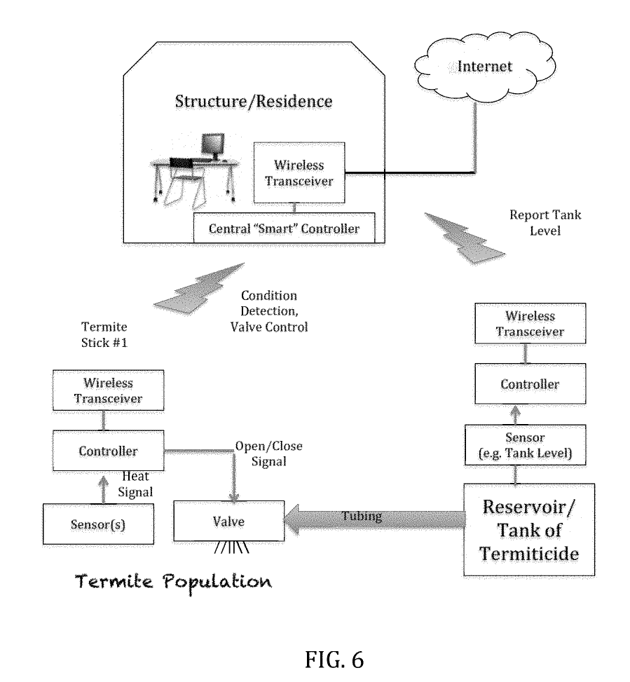

Referring ahead to FIG. 6, an overview of the system is shown. A structure/residence is surrounded by a lawn, where underground in the soil beneath the lawn a subterranean termite problem may exist.

A wireless transceiver of the residence is connected for Internet access service. The wireless transceiver may be a wireless access point (AP) for Wi-Fi access. Of course, other suitable wireless network technologies may be employed. The wireless transceiver is connected to a central (“smart”) controller (e.g. microcontroller, microprocessors, or the like, with program instructions).

A plurality of termite sticks are positioned around the residence, each being inserted at least partially underground. Each termite stick (one of which is shown in FIG. 6) may include a controller (e.g. microcontroller, microprocessors, or the like, with program instructions) and a wireless transceiver for communication with the wireless transceiver (and therefore the central controller) of the residence.

Each termite stick also includes one or more sensors which are disposed underground and used to detect one or more underground sensor characteristics (e.g. thermal heat or moisture level characteristics; seismic-type, vibrational, or acoustic characteristics indicative of air pockets or tunnels created by a subterranean termite population; or sound or acoustic levels produced by a subterranean termite population). The sensor characteristics are reported via the wireless transceiver to the central controller regularly, periodically, or when a predetermined characteristic is detected (e.g. the level reaches a predetermined threshold). The central controller determines whether a subterranean termite population is above a threshold based on the detected sensor characteristics, perhaps in combination with other characteristics.

Each termite stick also includes a dispenser or valve connected to a reservoir or tank via tubing or the like. The reservoir is filled with a treatment chemical, such as a termiticide. Control over opening/closing of the valves to dispense the termiticide at the termite sticks is decided and commanded by the central controller.

One or more other sensors may be employed at the reservoir for sensing a termiticide level (e.g. termiticide level is “LOW”). These one or more sensors are connected to a controller (e.g. microcontroller, microprocessor, or the like, with program instructions) which is connected to a wireless transceiver for communication with the wireless transceiver (and therefore the central controller) of the residence. The level of the tank may be reported regularly or periodically, or when a predetermined condition is detected (e.g. the tank is low), as examples.

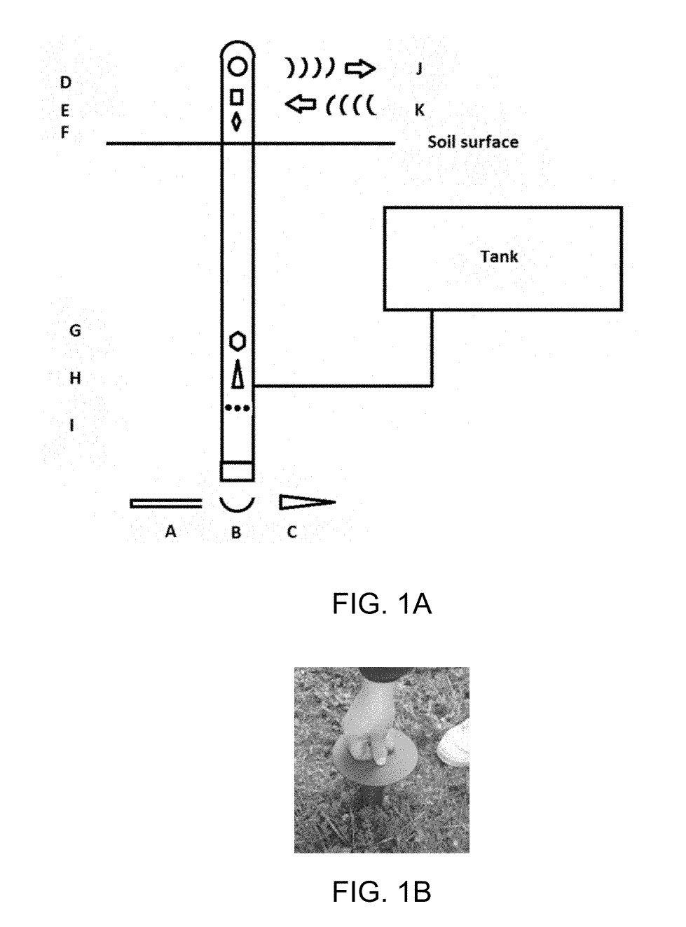

Referring to FIGS. 1A and 1B, termite sticks or probes may take the appearance as shown. The termite sticks can take on any length (e.g. from 0.5-6 feet long), and are at least partially embedded into the soil.

The termiticide or other treatment liquid is stored in a reservoir or tank and provided to the termite stick through a hose, tubing, or direct connection. A valve inside the bottom portion of the termite stick opens when the stick is engaged in treatment mode.

The part under the soil may administer the termiticide underground using one of three preferred strategies—direct dispensing either under or not under pressure through a nozzle (C), dispensing into a porous reservoir for gradual leaching into the soil (B), and dispensing into a tube or array of tubes which may be laser perforated for gradual leaching into the soil (A). With option C, technical difficulties created by clogging by particulate matter underground could be ameliorated through the use of metallic sieves/screens and scheduled use to prevent build-up or desiccation around the nozzle head.

Thus, the termiticide may be dispensed from a discrete reservoir that leaches the termiticide into the soil in a relatively small area around the termite stick, or dispensed under pressure through a nozzle structure, or dispensed through a small network of nozzles laid out in an array or ring around the termite stick or embedded in the termite stick around its circumference.

Both the top and the bottom of the termite stick contain various sensors for use in sensing one or more sensor characteristics, for use in determining when the termite stick should be activated into a treatment mode.

Under the soil, in the bottom portion of the termite stick, heat sensors (G), which may be thermocouples or may use infrared imagery into specialized chambers or directly into the soil, and moisture sensors (H) may be used, along with other sensors such as pH sensors, vibration sensors, and acoustic sensors.

Above the soil, in the top portion of the termite stick, various other sensors such as weather sensors (D), which may include wind speed, temperature, humidity, insolation etc., a camera (E) for colorimetric determination of lawn state (green-ness), as well as for visual monitoring of the surface, and a laser (F) for determination of other characteristics of the lawn state, such as the height of the lawn.

The termite stick communicates with a controller box or controller through wireless (J) or wire-based networks. Sensor data is sent to the controller, which integrates this data with various other forms of data, including real-time weather data, user preferences, history, etc., to determine a treatment schedule. This schedule is sent back to the termite stick via wireless (K) or wired connection and executed by the termite stick through a discharge of termiticide through methods A, B, or C.

Customers who have the system installed may engage in a service contract that provides for the tanks to be monitored and filled when necessary, for example, by qualified pest-control experts. System performance data are stored online, and the algorithm to make automated decisions about when to treat and how much to treat may be adjusted with manual settings via a PC or mobile phone based Internet connection.

The system may be completely automated, replacing the outdated and flawed termite detection system. The overlapping thermal heat and moisture sensor eliminates guess work and labor-intensive, manual checking methods. After detection, a precise amount of termiticide may be dispensed according to the label of the chemical—any and all faulty applications are eliminated. This will benefit the customer, the pest and termite company, and the environment, as unnecessary chemical applications are eliminated. Furthermore, the automated aspect allows for the more frequent use of organic termiticides to achieve the same net effectiveness—further helping the environment by eliminating the use of more harmful petroleum-based chemicals.

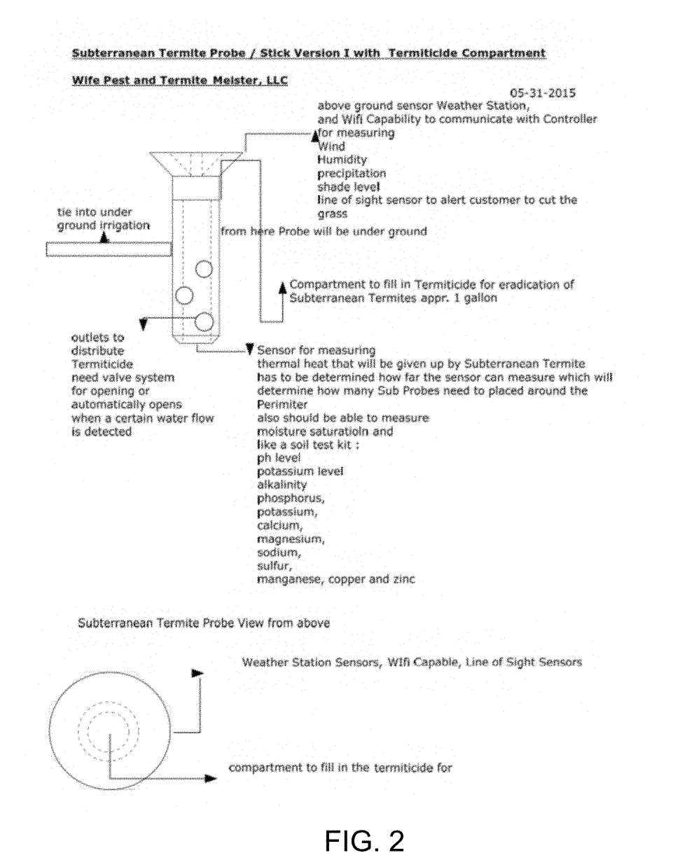

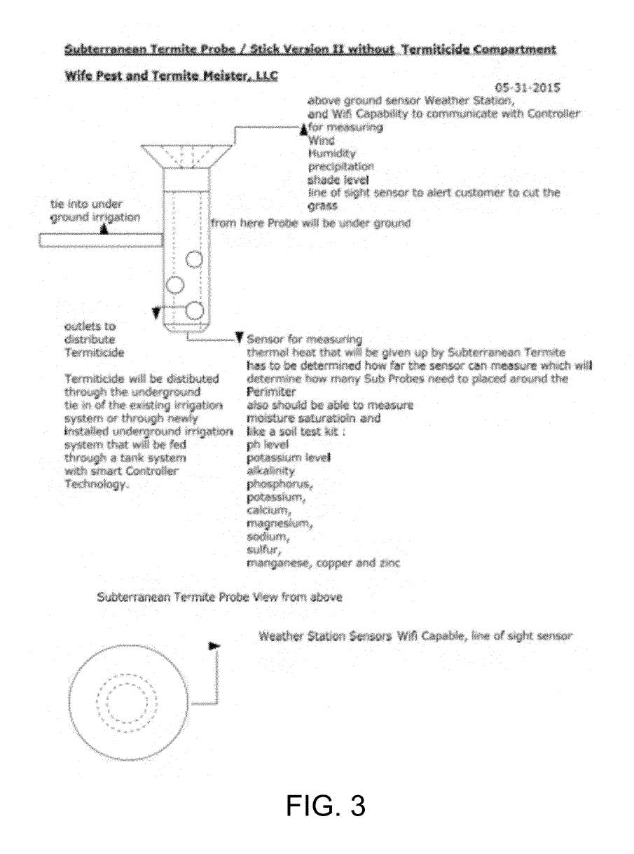

FIG. 2 shows another design of a termite stick having a termiticide compartment or reservoir, and FIG. 3 which does without a termiticide compartment or reservoir. Here, the termite stick takes a shorter, stouter design appearance, and the sensors are located in different places. With both of these designs, the termite stick is plumbed into a stand-alone piping system from a centralized tank. On the other hand, this could just as easily be plumbed into an existing sprinkler irrigation system for surface application of termiticide from distributed termite stick specific tanks. With the stand-alone, separate piping system (distinct from existing irrigation/sprinkler system), the termiticide in a centralized tank is pumped through the piping system, and into each termite stick, and then out of the termite stick into the surrounding soil, underground, regulated by the termite stick valve.

Discharge from the termite stick to the soil through nozzles, discharge vessels or drip irrigation tubing as in FIG. 1A and described later, and is regulated by the valve, which is controlled by a separate controller in wireless or wired communication with the network of termite sticks.

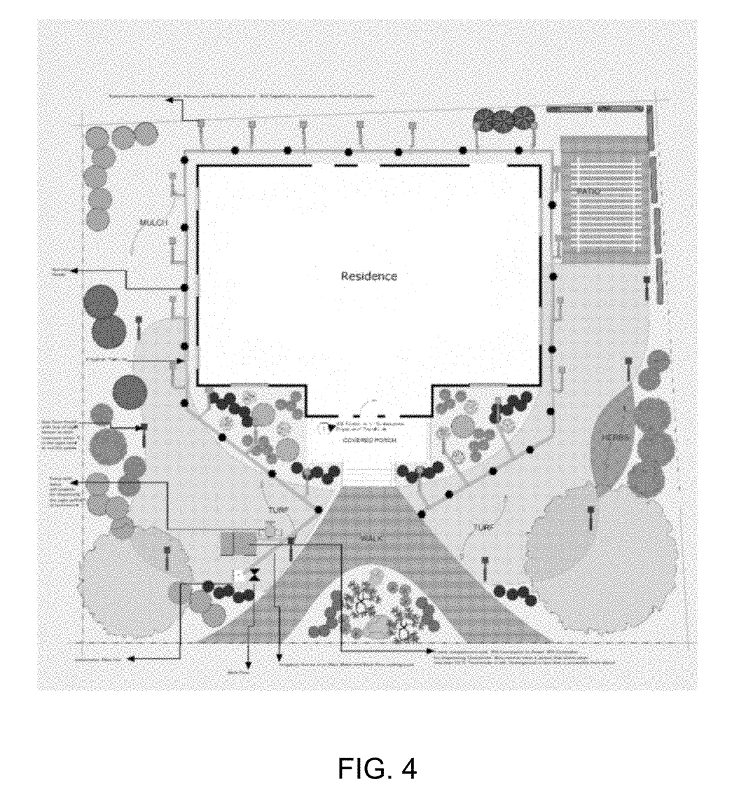

In FIG. 4, a typical layout of termite sticks for a typical residence is shown. Here, the termite sticks, taking the forms as shown in FIG. 2, for example, form a semicircular protective ring. The termite sticks here serve mainly as a sensor package, without dispenser capability. The tripartite tank containing termiticide, organic pesticide and organic fertilizer is plumbed directly into a surface sprinkler irrigation system. A valve between the tank pump and the irrigation system is controlled by the controller, which bases its decisions on the data provided by Wi-Fi-connected termite sticks. This layout/system is for surface termiticide application only, through a typical, existing sprinkler system.

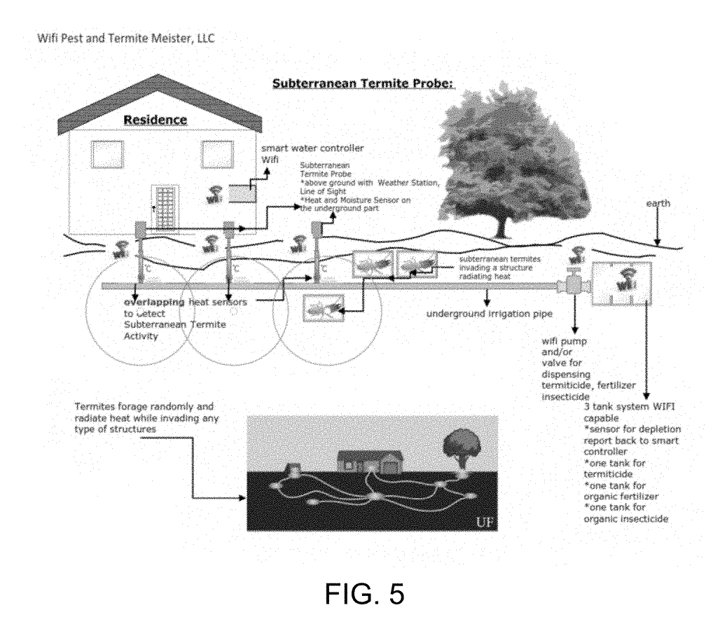

FIG. 5 shows a termite stick system where the termite sticks represent not only sensor packages, but also dispensers or valves for regulating above and/or below ground release of termiticide from a dedicated piping system connected to a reservoir or tank. Here, the termite sticks may take the form as shown in FIG. 3, for example, where each termite stick is not only a sensor package but a valve gateway for the release of termiticide either above and/or below ground. If the termite sticks are positioned appropriately, the range of detection for the sensors in each termite stick can be overlapping, forming a continuous detection ring around the structure (e.g. a house). For underground application of termiticide, if the dispense approach (nozzle type, or discharge chamber size/pressure) is optimized for covering several tens of feet of soil diameter around the base of the termite stick, the applied termiticide may form an overlapping and continuous ring of protection around the structure.

With this layout in FIG. 5, there is one reservoir or tank containing three compartments—one for termiticide, one for organic fertilizer, and one for organic pesticide. The tank is connected to a dedicated piping network underground, which feeds each of the termite sticks. Valves in the termite sticks, opened and closed by signals from the central controller, regulate the passage of termiticide, pesticide, and/or fertilizer through the termite stick for either surface or underground discharge.

The decision of which termite sticks are discharging, and whether the discharge is surface and/or underground is made by the controller which incorporates sensor data on ambient pest/soil conditions, atmospheric conditions from both the termite stick as well as forecast data from the Internet and user preferences through an online system management software application.

Another variation on the general idea is to use the termite sticks as gatekeepers for a physical, not just chemical, moat-like system against termites. With the approach shown in FIGS. 4 and 5, the termiticide, pesticide, or fertilizer is released from the termite stick and a protective barrier, formed as a continuous chemical barrier around a structure, is provided from a proper layout and positioning of the termite sticks. In this third variation, a physical barrier may be formed. Here, the termite sticks serve the same basic role, where sensors are used to measure when termiticide is needed, resulting in the dispense of termiticide, however here the termiticide is pumped into a tubing system that encircles a structure that would suffer termite damage. This tubing may be porous, created using laser or mechanical perforation or otherwise created micro pores for the weeping or leakage of termiticide from inside the hosing to the soil environment outside the hosing. Such tubing is commonly employed for drip irrigation, and would be buried from a few inches to feet below the soil surface, and effectively serve as a physical moat forming a continuous protective ring (either in the form of a semicircle or complete circle) of protection around the home/structure. The pressure of termiticide inside the tubing and flow rate, would dictate the amount and timing of treatment, and be regulated by the sensor/control box system based on either ambient needs, projected needs or with respect to a particular treatment timeline regimen. With this approach, the termiticide released could be more easily be ensured to itself form a continuous protective ring since we are not as reliant on soil absorption dynamics to form the ring. This is important because one challenge with such a system is getting an even and continuous distribution of product around the structure to be protected.

Other components of the system besides the controller and termite stick include the valve and pump, both of which will communicate with the controller by either wired or wireless (Wi-Fi) in order to adjust the flow rate. The flow rate will be set by the controller based on data provided from the termite stick and from online. The termite stick will be able to measure line of sight with other termite sticks to measure the height of the existing lawn. Once a certain height is reached (e.g. St. Augustine grass 5 inches height), it will alert the customer and/or the landscape company that cutting is necessary by one (1) inch. For healthy lawns it is imperative to cut certain grasses at a certain height to avoid any diseases and/or insect attacks and maintaining the grass height levels is an important part of our termite (indeed, insect) control system. Most homeowners ignore this fact.

A termite stick may also be able to measure the soil chemistry underground. Soil testing on a regular basis by the termite sticks, using various sensors such as conductivity sensors, will alert the customer and/or lawn and landscape company of fertilization needs. The termite stick may test for pH level (alkalinity), conductivity, and select elements such as phosphorus, potassium, calcium, magnesium, sodium, sulfur, manganese, copper, and zinc (e.g. using commonly available selective chemical sensors). The results are reported back to the controller, via Wifi or over a wired connection, and the customer and/or lawn and landscape company are alerted if levels indicate that fertilization is needed, and also if irrigation is needed (e.g. either above or below ground).

For electrical power, a termite stick may be wired for connection to the house mains, or may alternatively be a solar-powered. With the latter, a small solar cell and a solar-charged battery serving all of the termite stick functions may be provided.

A termite stick may also incorporate an LED light for decorative purposes, as well as to indicate where the termite stick is protruding from the ground. The top of a termite stick may also be fashioned as a landscape rock, a flower pot, or even a plant to conceal the termite stick.

Example identification and application. The system is of the style in FIGS. 2, 3, and 4, with a dedicated piping system from a tripartite tank. The Wi-Fi enabled controller is tied into a home-based Internet connection either using wired or wireless connection for retrieving weather forecast information. The weather forecast is for rain in the next 3 days then a dry spell. The controller is fed information from the termite stick sensor package which reports three of the installed sticks in a twelve (12) termite stick network are reporting unusually high underground temperatures measured by the thermocouple termite stick, and confirmed by the IR imaging termite stick, indicative of termites, lower than normal pH possibly indicating the release of uric acid, also potentially indicative of termite activity, vibration of a frequency compatible with termite mandible probing. The sensor package also reports to the controller that the soil is dry, indicating there will be good absorption and capillary pull for applied termiticide. Through the online systems management software package, the user indicates that treatment can be applied when the system determines it is necessary and appropriate. The system determines that termiticide treatment is necessary for the three (3) relevant termite sticks, plus one on either side as insurance, and that the best time to treat will be two (2) days after the rain ends in the early evening hours. It also determines based on the sensor and prediction data that treatment should be underground, that soil conditions are not appropriate for fertilizer application and that regularly scheduled surface pesticide treatment is not due. Furthermore, the user has St. Augustine grass, which is known by the controller to grow well in nearly all soil types and is tolerant to shade, heat and to some degree drought, and depending on the ambient conditions, usually requires watering every 5-10 days to maintain a dull, bluish color with rolled or folded leaves and persistent footprints. Based on the slope of the customer's lawn, the weather forecast, and the type of grass the controller determines that at the time termiticide treatment is warranted and to be applied in five (5) days, no surface or subsurface irrigation will be necessary or useful. Multiple email alerts are generated, and a graphic chart for animation of treatment plans, chemical levels and sensor data including the precipitation/weather forecast are provided the user. Five (5) days later, the system goes into application mode. The processor in the controller determines the saturation factor for the level of the termite chemical in the tank. According to the saturation factor measurements the dispense unit/valves, software is calibrated to automatically through the relevant stick dispense unit/valves for the right amount of chemicals that needs to be fed into the ground. The controller thus determines that the valve is to remain open for thirty (30) minutes, and the pump to maintain a determined pressure of ten (10) PSI to provide the necessary soil penetration and “ring” of protection around each stick to achieve a continuously treated area within legal limits for the chemical covering all five (5) of the termite sticks. The controller sends a signal to the five (5) termite sticks for this function, the pump is activated, and the underground application valves are opened at each of the 5 termite sticks. After 30 minutes, the valve then is closed and the pump is shut off by the controller. Sensors in the reservoir alert the pest control service provider that the termiticide compartment needs topping off. In addition, the above ground digital camera and laser grass height monitor alert the user that lawn cutting is needed within the next 7 days. Five days after the rains end and three (3) days after the termite sticks have treated the infested soil, the sensor package registers that the heat levels, pH levels and acoustic levels below ground in the area of the five (5) termite sticks have all reached normal levels and no further treatment is recommended or executed. The user uses the residence as a vacation home and investment property, and lives two (2) states away; they monitor the lawn visually and parametrically through the systems management software application over the Internet. They encounter three (3) similar treatment episodes over the course of the year, and sleep peacefully in their primary residence two (2) states away knowing that their vacation/investment residence is being fully protected against termite damage, while enjoying a systematic means for determining when their grass should be cut, watered and fertilized. Three years later when the user sells the residence, the termite treatment history log is provided to the buyers and along with a termite inspection provides proof that not only is the residence termite free, but has likely—as certain as it is possible—to have always been so. The user also takes great satisfaction that only the necessary amount of termiticide has been applied, and that it was applied in a manner least likely to cause local watershed contamination. The user also enjoys reduced water bills provided by the smart irrigation functionality of the termite sticks, and enjoys looking at the results—a lush, insect-free lawn, through real time video images online.

With the present techniques, one or more different types of sensors are used to systematically and reliably determine whether or not termites are present. A termite stick may be inserted a couple of feet into the ground (e.g. such that its top is about six (6) inches above the ground). In the lower part of the termite stick, underground, sensors measure heat, pH, sound, and moisture—all of which can be indicative of termite activity. The top part of the termite stick may measure the ambient atmospheric conditions, grass conditions and communicates with the controller for all sticks in a network through a wireless radio. The bottom part measures soil chemistry, heat using thermocouples and/or IR imagery cameras, pH, and possibly acoustics as well for detecting the signature created from the termite mandibles as they chew on wood.

The controller considers the sensor data from all sticks in the network, as well as online weather data, and user preferences to determine a treatment schedule. This schedule is disseminated to the appropriate sticks wirelessly, and those sticks actuate a valve in the bottom portion of the termite stick that releases termiticide from a tank into the soil. Treatment, as well as monitoring/detection are fully automated, and obviate the uncertainty, unreliability and huge labor expenses associated with the current state-of-the-art.

The technique is unique in that it provides an automated, hands-free termite detection with a systematic approach with potentially multiple measurements. Pest control may be accomplished underground using special underground dispensers. The system may be plumbed into existing sprinkler systems to achieve both underground as well as surface treatment. Other techniques may provide only surface treatments using “chemicals” and “smart controllers,” but none make use of a coordinated underground/surface treatment system.

The system may be utilized for underground irrigation, if instead of termiticide the termite stick is used to release water at depth in the soil. We could also plumb into existing sprinkler systems to achieve surface irrigation at the same time. Irrigation below ground is potentially useful because roots are below ground, and irrigation serves strictly to hydrate root systems. Surface irrigation towards this end, where only a fraction of the water seeps down to the root, results in a lot of waste due to evaporation and runoff. Irrigating underground keeps the soil moist longer because the water is placed directly where needed—near the roots—and more of the water dispensed is actually used rather than wasted. Overall less water need be used. Other techniques provide “smart irrigation” systems for reducing water wastes based on the determination of appropriate conditions (weather, moisture levels etc.) and parameters (soil type, slope, type of plant etc.) for surface irrigation through existing sprinkler or other crop irrigation systems, but no system has been devised that integrates both surface and underground irrigation to achieve water efficiency. Towards this end, the top portion of each termite stick could use cameras for RGB colorimetry.

The use of ambient weather data (wind speed, temperature, humidity etc.) in addition to the use of online data may be added, for optimizing pest control weather-related decision making such as time of day and day of week/month to treat etc. Further, the use of visual monitoring sensors (IR and visual cameras, lasers) for optimizing pest control related decision making such as grass height, time to treat etc. may be provided.

The sensor package and dispenser (nozzle) may be encapsulated into a single package for precise point-of-care sensing and treatment.

The system is focused on the need to protect the residence from termites, rather than the need to maintain a lush lawn. All decision making factors the protection of the home from termites as its first priority. If the termite problems are bad and recurring, during the summer months, and the system decides not to irrigate but to only chemirrigate, lawn health may suffer temporarily. Existing systems in the literature are always designed to prevent lawn health deterioration as their first and usually only priority.

Myriad similar systems have been described that accomplish surface irrigation or chemirrigation including pest control or fertilization. However, the water or chemicals applied to the surface are subject to run-off and/or evaporation before they can serve its purpose. The aim of smart irrigation is to minimize the likelihood of this by choosing times for irrigation/chemirrigation that are optimal—such as on days when it is not already raining, or when the soil is saturated from a prior week of rain—and undoubtedly they take positive steps in this direction. For example, various patent publications describe adjusting irrigation based on moisture levels usually directed towards agricultural fields, and these systems could be set to allow irrigation when the soil is in a certain moisture range for maximum absorption, or for only those parts of the field where water is needed. But by being surface irrigation/chemirrigation systems, the water or chemicals applied to the surface is still subject to some loss by runoff or evaporation. As strictly an irrigation device, our invention avoids water loss altogether by placing the water where it is needed—at the roots to maximally minimize runoff or evaporation. As a termite control device, in placing the termiticide below ground, minimal losses are ensured and termite-specific protocols which usually require the digging of ditches and the manual spreading of termiticide in the ditch can be adhered to in an automated, efficient and cost-effective manner by eliminating the human labor component of the exercise.

Detection of Air Pockets or Tunnels Created by Subterranean Termites Based on the Monitoring/Sensing of Seismic-Type, Sound, Vibrational, and/or Acoustic Waves, or the Like.

A particular embodiment which makes use of a particular type of detection of subterranean termite populations is now described. As mentioned previously, such embodiment makes use of monitoring/sensing of seismic-type, sound, vibrational, and/or acoustic waves for the detection of subterranean termite populations. For example, the embodiment may make use of a type of reflection seismology (e.g. technology utilized largely in the oil and gas industry) for the detection of air pockets, holes, or tunnels created by subterranean termite populations.

Reflection seismology (or seismic reflection) may be characterized as a method of exploration geophysics that uses the principles of seismology to estimate the properties of the Earth's subsurface from reflected seismic waves. The method employs a controlled seismic source of energy. Reflection seismology is similar to sonar and echolocation.

Seismic waves are mechanical perturbations that travel in the Earth at a speed governed by the acoustic impedance of the medium in which they are travelling. The acoustic (or seismic) impedance, Z, is defined by the equation:

Z=Vρ,

where V is the seismic wave velocity and ρ (Greek rho) is the density of the rock.

When a seismic wave travelling through the Earth encounters an interface between two materials having different acoustic impedances, some of the wave energy will reflect off the interface and some will refract through the interface. The seismic reflection technique may involve generating seismic waves and measuring the time taken for the waves to travel from the source, reflect off an interface, and be detected by an array of receivers (or geophones). Knowing the travel times from the source to various receivers, and the velocity of the seismic waves, the pathways of the waves are reconstructed in order to build up an image.

In the case of subterranean termite detection, an interface between the soil and an air pocket, hole, or tunnel (e.g. air) created by a subterranean termite population may be made. Accordingly, the detection or identification of such a tunnel is a detection or identification indicative of a subterranean termite population.

In common with other geophysical methods, reflection seismology may be viewed as a type of inverse problem. That is, given a set of collected data and applicable physical laws, an abstract model may be developed of the physical system being studied. In the case of reflection seismology, the data are recorded seismograms, and the desired result is a model of the structure and physical properties of the Earth. In common with other types of inverse problems, the results obtained from reflection seismology are usually not unique (more than one model adequately fits the data) and may be sensitive to relatively small errors in data collection, processing, or analysis.

A principle of seismic reflection is to send out waves (e.g. elastic waves) with an energy source into the Earth, where each layer within the Earth reflects a portion of the wave's energy back and allows the rest to refract through. The reflected energy waves are recorded over a predetermined time period, which may be called the record length, by receivers that detect the motion of the ground in which they are placed. On land, one typical receiver used is a small, portable instrument known as a geophone, which converts ground motion into an analog electrical signal. Each receiver's response to a single shot is known as a “trace” and is recorded in storage. The shot location may then be moved along and the process repeated. Typically, the recorded signals are subjected to significant amounts of signal processing before they are ready to be interpreted (note that this is an area of significant active research within industry and academia).

When a seismic wave encounters a boundary between two materials with different acoustic impedances, some of the energy in the wave will be reflected at the boundary while some of the energy will be transmitted through the boundary. Again, in the case of subterranean termite detection, an interface between the soil and an air pocket, hole, or tunnel (e.g. air) created by a subterranean termite population may be made. The amplitude of the reflected wave is predicted by multiplying the amplitude of the incident wave by the seismic reflection coefficient R, determined by the impedance contrast between the two materials.

For a wave that hits a boundary at normal incidence (head-on), the expression for the reflection coefficient is simply

$$R = \frac{( {Z}_{1} - {Z}_{0} )}{( {Z}_{1} + {Z}_{0} )} ,$$

where Z₀ and Z₁ are the impedance of the first and second medium, respectively. Similarly, the amplitude of the incident wave is multiplied by the transmission coefficient to predict the amplitude of the wave transmitted through the boundary. The formula for the normal-incidence transmission coefficient is

$$T = \frac{2 {Z}_{0} {Z}_{1}}{( {Z}_{1} + {Z}_{0} )} . \qquad [ 2 ]$$

As the sum of the squares of amplitudes of the reflected and transmitted wave has to be equal to the square of amplitude of the incident wave, it may be shown that

$$1 - {R}^{2} = \frac{{( {Z}_{1} + {Z}_{0} )}^{2} - {( {Z}_{1} - {Z}_{0} )}^{2}}{{( {Z}_{1} + {Z}_{0} )}^{2}} = \frac{4 {Z}_{0} {Z}_{1}}{{( {Z}_{1} + {Z}_{0} )}^{2}} = {T}^{3} .$$

By observing changes in the strength of reflectors, changes in the seismic impedances may be identified or inferred. In turn, this information may be used to identify or infer changes in the properties of rocks at the interface, such as the density and elastic modulus.

The time it takes for a reflection from a particular boundary to arrive at the geophone is called the travel time. If the seismic wave velocity in the rock is known, then the travel time may be used to estimate the depth to the reflector. For a simple vertically traveling wave, the travel time t from the surface to the reflector and back is called the Two-Way Time (TWT) and is given by the formula

$$t = 2 \frac{d}{V} ,$$

where d is the depth of the reflector and V is the wave velocity in the rock.

A series of apparently related reflections on several seismograms is often referred to as a reflection event. By correlating reflection events, an estimated cross-section of the geologic structure that generated the reflections may be created.

Again, this type of wave sensing may be utilized to distinguish between the soil and an air pocket, hole, or tunnel (e.g. air) created by a subterranean termite population. Accordingly, the detection or identification of such an air pocket or tunnel is a detection or identification indicative of a subterranean termite population. The shape, length, and/or size of such a tunnel may be taken in consideration in detection or identification. The techniques described above in relation to the figures may be employed in the same or similar manner as described, but with use of such wave sensing.

As an example, a central source (e.g. at a stick) may be configured to send waves underground, where a plurality other sticks may be configured to receive and report the reflected waves in response (e.g. regularly or periodically). On the other hand, a plurality of sticks may be configured to send waves and a plurality of other sticks may be configured to receive waves. Finally, each stick may be configured to both send waves to a corresponding stick and receive waves from another corresponding stick.

Note that alternatives to the sensing of seismic-type, sound, vibrational, or acoustic waves may be utilized. For example, sensing of radio frequency (RF) waves, electromagnetic waves, ultra-sonic waves, or infrared waves may be utilized as alternatives.

Detection of Subterranean Termites Based on the Monitoring/Sensing of Sounds, Acoustics, or Vibrations Produced by the Subterranean Termites.

Another embodiment which makes use of another type of detection of subterranean termite populations is now described. As mentioned previously, such embodiment makes use of the monitoring/sensing of sounds or acoustics produced by the subterranean termite population for the detection thereof. The sound or acoustics produced by a subterranean termite population is unique (e.g. it has unique frequency characteristics, sound durations, and/or sound patterns), and therefore they may be distinguished from other (e.g. noise) signals or sources. Note that, individually, the sound level of one or more termites may be relatively low; collectively, however, the sound level of a subterranean termite population may be large and exceed a threshold. A treatment need may be identified based on the level or amplitude of the sound/acoustics, and/or the frequency or duration or pattern of the sound/acoustics.

In this embodiment, a suitable sensor, such as a microphone, an acoustic sensor, a geophone, an accelerometer, a piezoelectric transducer, or an ultrasonic sensor, as examples, may be utilized at each termite stick. An amplifier and/or filter may also be employed at each sensor stick and/or the central controller.

Any suitable frequencies or frequency range(s), and/or other suitable characteristics, of the signals which may be generated by the termites may be monitored. Suitable signal processing and/or software may be employed as appropriate. These frequencies or frequency range(s), or other characteristics, may be remotely tunable and/or programmable. For example, the one or more filters employed may be tunable. This tunability/programmability may be useful since continued research of the appropriate characteristics may be ongoing, and depend on the species and/or types of pests to identify. The central controller, through its wireless transceiver, may remotely program the controller provided at each termite stick to update or add to such information.

A microphone or acoustic sensor may be employed above-ground as well, so that above-ground noise signals may be identified. The real-time above-ground noise signals or characteristics may be identified and sent wirelessly to the controllers at the termite sticks, and/or to the central controller, for use in filtering such noise from the underground sound/acoustic signals (i.e. the termite sounds).

Detection of Subterranean Termites Based on the Monitoring/Sensing/Detecting of a Change in Signals which Vary Based on a Change in the Value of a Property of a Transmission Line Characterized at Least in Part by a Conductor Cord or Strip Having a Termite-Gnawable and/or Termite-Edible Material.

In another embodiment, a sensor or sensor circuit may comprise a conductor cord or strip having one or more conductors and/or a termite-gnawable and/or termite-edible material. The conductor cord is for use in being disposed underground in the soil, perhaps along with the entire sensor or sensor circuit. A transmission line of the sensor circuit is characterized by the conductor cord, as well as by any effecting surrounding elements (e.g. soil or earth, water, or air) in the soil.

Here, the sensor or sensor circuit may further comprise a signal generator to produce signals in the conductor cord and a detector to detect changes in the signals. Detection of a subterranean termite population may be made by detecting a substantial or suitable change in the signals which vary based on or in accordance with a change in the value of a property of the transmission line. The property of the transmission line may be a dielectric property, a resistance or impedance property, or both (and/or any other suitable property or properties). The signals may vary based on changes in a transmission line characteristic of the transmission line.

This method may be further based on signal reflectometry techniques. For example, the method may employ Time Domain Reflectometry (TDR) techniques. TDR is a method that was introduced in the 1980's for sensing the amount of water content in soil. TDR is based on the measurement of the propagation velocity of an electromagnetic wave or signal along a transmission line (e.g. wave-guide) of length L disposed or embedded in the soil.

To illustrate, when a signal is transmitted or pulsed at a first end of a transmission line, it takes a time t for the signal to reach the second end of the transmission line. The time T is a function of the (impedance) characteristics or properties of an electrical conductor of the transmission line, as well the (impedance) characteristics or properties of the medium (e.g. the soil or soil minerals) that surrounds the electrical conductor.

Analysis of the signals may be based on the following relation

$${ɛ}_{b} = {( \frac{c}{v} )}^{2} = {( \frac{ct}{2 L} )}^{2} ,$$

where v=2 L/t, ε_{b} is the soil bulk dielectric constant, and c is the velocity of electromagnetic waves or signals in a vacuum (3×10⁸ m/s). The above-relation may be arranged to show that the time t it takes for the pulse signal to travel the length L of the transmission line is proportional to the square root of the dielectric constant of the surrounding media.

The dielectric constant of soil or soil constituents, such as soil minerals, is relatively low, between about 3-5. The dielectric constants of air and ice are also relatively low, at about 1 and 4, respectively. On the other hand, the dielectric constant of water is relatively high, at about 81. Thus, when water is present in the soil, the time t that it takes for a pulse signal to propagate through the transmission line is significantly longer than when water is not present.

In accordance with the present embodiment, a similarly suitable sensor or sensor circuit for termite monitoring and detection is employed (e.g. provided at “sensor(s)” in FIG. 6). Again, a sensor or sensor circuit of the present embodiment may comprise a conductor cord or strip having one or more conductors and/or a termite-gnawable and/or termite-edible material. The conductor cord is for use in being disposed underground in the soil, perhaps along with the entire sensor or sensor circuit. A transmission line of the sensor circuit is characterized by the conductor cord, as well as by any effecting surrounding elements (e.g. soil or earth, water, or air) in the soil.

Here, the sensor or sensor circuit may further comprise a signal generator to produce signals in the conductor cord and a detector to detect changes in the signals. Detection of a subterranean termite population may be made by detecting a substantial or suitable change in the signals which vary based on or in accordance with a change in the value of a property of the transmission line. The property of the transmission line may be a dielectric property, a resistance or impedance property, or both (and/or any other suitable property or properties). The signals may vary based on changes in a transmission line characteristic of the transmission line.

To illustrate, FIG. 7 shows a conductor cord 700 which may comprise dual conductors having a dielectric material/insulator between the conductors. Here, the conductor cord 700 may be or include a termite-gnawable material made from one or more different materials. In one example, the termite-gnawable material may be or include a wood-based material. The wood-based material may comprise one or more wood or wood-composite materials.

In one variation, the termite-gnawable material may further comprise or include a termiticide, or other suitable solution, chemical, or substance, which is attractive to termites. The termiticide may be absorbed and carried within the material. In another variation, the dielectric material may not only be termite-gnawable and/or termite-edible, but also poisonous or otherwise disruptive to termites. As one example, diflubenzuron may be utilized as a termite-gnawable and/or termite-edible material.

When foraging and ingressing into an area, termites will encounter the termite-gnawable material, and gnaw away at and/or eat one or more portions of the material. One or more gaps in the termite-gnawable material may thereby be produced. As a result, there is a physical, structural, mechanical, and/or size reduction of the termite-gnawable material. Viewing an example result, FIG. 8 reveals a (modified) conductor cord 800 with portions of the termite-gnawable material gnawed away, eaten, and/or missing. The gaps in the material may be filled with surrounding soil, air, or both (and/or other).

During system operation, one or more electrical signals (e.g. one or more pulse signals) may be produced or generated in the conductor cord, e.g. on a regular or repeated basis. Accordingly, the time T that it takes for the signals to travel in the conductor cord from one end to the other end may change based on and/or in accordance with the change (e.g. reduction) in the value of the dielectric property. A substantial or other suitable change (e.g. an increase) in the time T that the signals travel may result, which may be an indication that termites are present.

In this or other similar manner, it may be determined whether sensor characteristics in one or more of the underground soil regions are indicative of a subterranean termite population exceeding a threshold.

The termite-gnawable material(s) of the conductor cord or strip may be selected in advance of use to be one having a dielectric property with any suitable dielectric constant. A dielectric constant may be said to be a number denoting the ability of a material to resist the flow of electric current through it. Note that the termite-gnawable material(s) of the conductor cord may be selected in advance of use to be one having a dielectric property with any suitable dielectric constant that falls within a set range of suitable dielectric constants. The selection of the termite-gnawable material(s) having the suitable dielectric constant may be based on at least the value(s) of the dielectric constant(s) of the surrounding soil material(s) and/or possibilities thereof, the value(s) of the dielectric constant(s) of any surrounding water/rain and/or possibilities thereof, and/or the value(s) of the dielectric constant(s) of any surrounding termiticide and/or possibilities thereof.

In general, the termite-gnawable material(s) may have a dielectric constant that is generally greater than the surrounding soil (e.g. with or without water present). The dielectric constant of soil or soil constituents, such as common soil minerals, may be relatively low, at between about 3-5. Below is a list of various ground/earth materials for illustration.

TABLE A
Ground/Earth Materials and their Associated Dielectric Constants

| Ground Material | Dielectric Constant |
|---|---|
| Sand (dry) | 3-6 |
| Sand (saturated) | 20-30 |
| Silts | 5-30 |
| Shales | 5-15 |
| Clays | 5-40 |
| Humid soil | 30 |
| Cultivated soil | 15 |
| Rocky soil | 7 |
| Sandy soil (dry) | 3 |
| Sandy soil (saturated) | 19 |
| Clayey soil (dry) | 2 |
| Clayey soil (saturated) | 15 |
| Sandstone (saturated) | 6 |
| Limestone (dry) | 7 |
| Limestone (saturated) | 4-8 |
| Basalt (saturated) | 8 |
| Granite (dry) | 5 |
| Granite (saturated) | 7 |

On the other hand, the dielectric constant of any surrounding water is relatively high, at about 81.

Based on the known data, a suitable selection of a dielectric constant and/or material(s) may be made. Air has a dielectric constant of 1, and water has a dielectric constant of 80. Thus, one suitable termite-gnawable material and/or termite-edible material may have a dielectric constant within a set range of between 1 and 80. Of course, when such a material is eaten, it will be replaced by either air or water (moist soil). Thus, a termite-gnawable material and/or termite-edible material having a dielectric constant of 40 may be suitable, since it carries much different properties than air or soil.

As another example, another set range of values may be 50-60. Yet another example is a set range of values which is 60-70.

In one or many possible variations, the termite-gnawing and/or termite-edible material of the conductor cord or strip may have a resistance which varies the amount of current passing from one conductor (e.g. held at a positive voltage) to another (e.g. grounded) conductor. As the material is gnawed away, the material is replaced with soil and/or air and the resistance changes (e.g. increases). This change (e.g. increase) in resistance may produce a signal to indicate the existence of a subterranean termite population that exceeds a threshold.

The conductor cord or strip may be for use in inserting, disposing, and/or burying in the soil. One or more such conductor cords may be carried on connecting termite sticks sensors, distributed around a structure or area to be protected. In such a configuration, the termite sticks and connecting conductor cords may form a protective ring around a structure 900 (e.g. a residence) as shown in FIG. 9 (black line connecting sensors).

When the dielectric constant between any two sensors changes, signals are generated and sent to the controller, which can then initiate termiticide application through a separate circuit. Treatment decisions may be made through an internet cloud-based system, where the controller sends data from the sensors and other sources (e.g. user input) to the cloud, where third-party data can be incorporated to optimize treatment decisions, and signals sent back from the cloud to the controller to initiate treatment.

The wires could be buried alongside the separate subterranean termiticide applicator hose circuit and the chemicals delivered at the precise location the termite presence was detected. The rate of dielectric constant can be monitored and treatment decisions based on changes in this rate.

Treatment decisions may be made based on detecting the presence of termites. Further, treatment decisions may be based on whether the numbers are increasing. When the dielectric is eaten away, the pulse time or resistance of the cable changes and achieves a new baseline. Rather than replace the cable, the system can be automatically recalibrated to continue monitoring with the same cable. If treatment kills all of the termites, and dielectric material degradation ceases, the cable may last for many additional months or years until the next infestation/treatment. Only if a substantial fraction of the dielectric material is ingested by termites would the cable then need replacing.

FIG. 10 is an illustration of another example of a system configuration 1000 which makes use of one or more sensor circuits comprising one or more conductor cords or strips including a termite-gnawable material. A structure 1002 to protect, such as a residence, a garage, or tree, is shown. A plurality of termite sticks (e.g. a stick 1004) and a plurality of conductor cords (e.g. a conductor cord 1010) are disposed in a ring configuration underground within the soil around the structure 1002. Each stick 1004 may include or carry circuitry such as a signal generator 1006 and a detector 1008, circuitry which is associated with a corresponding conductor cord 1010. Note, however, that a single signal generator 1006 and detector 1008 pair may be associated with two or more conductor cords.

A method of installing the system configuration 1000 of FIG. 10 in relation to the structure 1002 may be as follows: (1) excavating or digging or forming a trench or a slit in the soil at least partially around the structure to be protected; (2) providing at least one sensor or sensor circuit including a conductor cord or strip comprising a termite-gnawable and/or termite-edible material; (3) disposing the conductor cord or strip in the trench or slit, at least partially around the structure to be protected; and (4) activating the sensor circuit for operation (e.g. the sensor circuit may further include a signal generator to produce signals in the conductor cord and/or a detector to detect changes in the signals). A transmission line of the sensor circuit is characterized by conductors of the conductor cord, as well as by any effecting surrounding elements (e.g. soil or earth, water, or air) in the soil. Detection of a subterranean termite population may be made by detecting a substantial or suitable change in the signals which vary based on or in accordance with a change in the value of a property of the transmission line. The property of the transmission line may be a dielectric property, a resistance or impedance property, or both (and/or any other suitable property or properties). The signals may vary based on changes in a transmission line characteristic of the transmission line.

Advantages of this method include: (a) detection without gaps—any piercing of the “shield” or “ring” around the area to be protected can be detected; (b) localization possible—where in the cable the dielectric has been ingested can be determined; (c) ease of sensing with low levels of power—the method is relatively straightforward, functional on low voltage/power and therefore not only less technically challenging than for example the seismic method, but compatible with alternative energy sources such as photovoltaics; (d) Manufacturability—fabrication of the conductor/dielectric sandwich cables should be relatively straightforward; (e) affordability—fabrication of the conductor/dielectric sandwich cables should be relatively inexpensive.

Alternatives to Termiticide and/or Tank May be Used for Treatment—E.g. Transmission of Sound/Acoustic Waves.

An alternative to utilizing a reservoir/tank and associated termiticide may be employed. In one instance, when a treatment need is identified, a sound or vibrational wave or signal may be produced at one or more frequencies known to control a subterranean termite population (e.g. causes the termites to scatter or retreat) over one or more time periods. Any suitable frequencies may utilized, for e.g. from 5 Hz to 5 kHz. Any suitable sound transmission element (e.g. speaker device) may be utilized as well. For example, a super-magnetostrictive element may be employed. Such elements may be utilized at each termite stick, commanded by the central controller via the wireless transceiver. Alternatively here, an electromagnetic wave or signal, a radio frequency (RF) wave or signal, an ultrasonic wave or signal, etc. known to cause termites to scatter or retreat may be produced.

Any suitable frequencies or frequency range(s), and/or other suitable characteristics, of the emitted signals which may control the termites may be utilized. These frequencies or frequency range(s), or other characteristics, may be remotely tunable and/or programmable. This tunability/programmability may be useful since continued research of the appropriate control characteristics may be ongoing, and depend on the species and/or types of pests to control. The central controller, through its wireless transceiver, may remotely program the controller provided at each termite stick to update or add to such information.

Use of Emitted Sound/Acoustic (or Other) Waves for Attracting Termites.

Also as an option, a sound or vibrational wave or signal may be produced at one or more frequencies known to attract or draw near a subterranean termite population for a particular need. For example, such a signal may be emitted to attract the subterranean termite population closer to a sensor (e.g. any one of the termite sensors) for better detection, and/or closer to a termiticide dispenser or other treatment device for treatment. Any suitable sound transmission element at any suitable frequency may be utilized. For example, a super-magnetostrictive element may be employed. Such elements may be attached to or carried on each termite stick, being collocated with the sensor(s) and/or dispensers. Alternatively here, an electromagnetic wave or signal, a radio frequency (RF) wave or signal, an ultrasonic wave or signal, etc. known to attract or cause termites to draw near may be employed.

Any suitable frequencies or frequency range(s), and/or other suitable characteristics, of the emitted signals which may control the termites may be utilized. These frequencies or frequency range(s), or other characteristics, may be remotely tunable and/or programmable. This tunability/programmability may be useful since continued research of the appropriate control characteristics may be ongoing, and depend on the species and/or types of pests to control. The central controller, through its wireless transceiver, may remotely program the controller provided at each termite stick to update or add to such information.

Although a few embodiments of the present invention have been shown and described, the present invention is not limited to the described embodiments. It is appreciated by those skilled in the art that changes may be made to the embodiments without departing from the principles and spirit of the invention, the scope of which is defined by the claims and their equivalents. For example, combinations of two or more of the monitoring/sensing techniques may be utilized for higher accuracy in the detection of subterranean termite populations. As another example, an organic termiticide of any suitable type may be used in place of standard termiticide. As yet another example, any suitable pest or insect (e.g. other than termites) may be monitored and treated. As yet even another example, any suitable structure other than a residence may be protected, e.g. a garage, a tree, a garden, etc.

What is claimed is:

1. A method for use in controlling subterranean termite populations, the method comprising:
monitoring sensor characteristics in a plurality of underground soil regions, with use of a sensor including a conductor cord comprising a termite-gnawable material;
determining whether one or more of the sensor characteristics in one or more of the underground soil regions are indicative of a subterranean termite population exceeding a threshold;
identifying a treatment need at regions corresponding to the one or more underground soil regions based on the determining; and
executing the treatment need at the regions corresponding to the one or more underground soil regions.

2. The method of claim 1, wherein the executing of the treatment need comprises controlling the release of termiticide from a reservoir for release at regions corresponding to the one or more underground soil regions.

3. The method of claim 1, wherein the executing of the treatment need comprises producing a sound or acoustic wave to control the subterranean termite population.

4. The method of claim 1, wherein the monitoring of the sensor characteristics comprises monitoring generated waves underground for detection of an air pocket, hole or tunnel created by a subterranean termite population.

5. The method of claim 4, wherein the generated waves comprise seismic waves, vibrational waves, or acoustic waves.

6. The method of claim 1, wherein the monitoring of the sensor characteristics comprises the monitoring of sound or acoustic waves produced by a subterranean termite population.

7. The method of claim 6, wherein the monitoring of the sound or acoustic waves produced by a subterranean termite population utilizes a microphone or accelerometer.

8. The method of claim 1, wherein the monitoring of the sensor characteristics comprises the monitoring of thermal heat characteristics in the plurality of underground soil regions.

9. The method of claim 1, wherein the monitoring of the sensor characteristics comprises monitoring moisture levels in the underground soil regions.

10. The method of claim 1, wherein the monitoring of the sensor characteristics comprises the monitoring of one of a pH level of the soil, a vibration level, an acoustic level, and a mineral level of at least one mineral.

11. The method of claim 1, further comprising:
wirelessly communicating the sensor characteristics from the underground soil regions to a controller.

12. The method of claim 1, wherein the monitoring of the sensor characteristics comprises the monitoring of the characteristics at a plurality of termite sticks which are at least partially inserted in the ground, the method further comprising:
wirelessly communicating the sensor characteristics from the termite sticks to a controller.

13. The method of claim 1, further comprising:
wirelessly communicating the sensor characteristics from the underground soil regions to a controller; and
performing the determining, the identifying, and the controlling in the controller.

14. The method of claim 1, wherein the sensor characteristics comprise first characteristics, the method further comprises:
monitoring one or more second characteristics;
determining whether one or more of the second characteristics are indicative of a subterranean termite population exceeding a threshold; and
identifying the termiticide dispense need based on the determining associated with the one or more first and second characteristics.

15. The method of claim 1, wherein the sensor characteristics comprise first characteristics, the method further comprises:
monitoring one or more second characteristics;
determining whether the one or more of the second characteristics are indicative of favorable or unfavorable conditions to execute the treatment need; and
delaying the execution of the treatment need based on the determining of unfavorable conditions to execute the treatment need.

16. The method of claim 13, further comprising:
determining a date and/or time, or a delay time, for executing the treatment need.

17. The method of claim 1, wherein the second characteristics comprise a weather characteristic including one of a temperature, a humidity, a wind speed, and an insolation.

18. The method of claim 2, wherein the controlling of the release of termiticide is performed underground at the one or more underground soil regions.

19. The method of claim 2, wherein the controlling of the release of termiticide is performed at above-ground regions corresponding to the one or more underground soil regions.

20. The method of claim 2, wherein the controlling of the release of termiticide is performed underground and above-ground.

21. A system for use in controlling subterranean termite populations, the system comprising:
a plurality of termite sticks;
at least one sensor attached to a termite stick for sensing a characteristic underground where the termite stick may be at least partially inserted;
a reservoir configured to hold a termiticide and connect to a plurality of dispensers; and
a controller configured to receive data from the sensors and to control release of the termiticide via one or more of the dispensers based on assessing the data.

22. The system of claim 21, wherein the controller is configured to determine whether the data are indicative of a subterranean termite population exceeding a threshold, identify a termiticide dispense need based on the determining, and control the release of termiticide via the one or more dispensers based on the identifying.

23. The system of claim 21, wherein the at least one sensor comprises a seismic, vibrational, or acoustic wave sensor for detection of an air pocket, hole or tunnel created by a subterranean termite population.

24. The system of claim 21, wherein the at least one sensor comprises a sensor, such as a microphone or an accelerometer, for detection of sound or acoustic waves produced by a subterranean termite population.

25. The system of claim 21, wherein the at least one sensor comprises a thermal heat sensor.

26. The system of claim 21, wherein the at least one sensor comprises a moisture level sensor.

27. The system of claim 21, wherein the dispensers are included on the termite sticks.

28. The system of claim 21, wherein the dispensers dispense the termiticide underground, above-ground, or both underground and above-ground.

29. The system of claim 21, wherein the at least one sensor is of a first type for sensing a first characteristic, and each termite stick further includes an additional sensor of a second type for detecting a second characteristic.

30. The system of claim 21, wherein in lieu of utilizing the reservoir, the termiticide, and the dispensing thereof, the system comprises:
a sound transmitting element to produce a sound or acoustic wave to control the subterranean termite population.

31. The system of claim 21, further comprising:
the controller being coupled to a first wireless transceiver;
each termite stick being coupled to a second wireless transceiver; and
each second wireless transceiver communicating, to the controller, wireless signals carrying the data.

32. A device for use in controlling subterranean termite populations, the device comprising:
a stick configured to be inserted at least partially underground;
at least one sensor attached to the stick and configured to sense at least one sensor characteristic underground indicative of a subterranean termite population; and
a wireless transceiver configured to wirelessly communicate, to a controller, the at least one characteristic for identifying a treatment need with respect to the subterranean termite population.

33. The device of claim 32, further comprising:
a dispenser carried on the stick and configured to release a termiticide in response to a command from the controller received via the wireless transceiver.

34. The device of claim 32, wherein for the treatment need, the device further comprises:
a sound transmitting element to produce a sound or acoustic wave to control the subterranean termite population.

35. The device of claim 32, wherein the at least one sensor comprises a seismic, vibration, or acoustic sensor.

36. The device of claim 32, wherein the at least one sensor comprises a sensor, such as a microphone or an accelerometer, for detection of sound or acoustic waves produced by a subterranean termite population.

37. The device of claim 32, wherein the at least one sensor comprises a thermal heat sensor or a moisture level sensor.

38. The device of claim 32, wherein the wireless transceiver comprises a Wi-Fi transceiver.

39. The method of claim 1, wherein the monitoring of the sensor characteristics is performed with use of a sensor including a conductor cord or strip comprising a termite-gnawable material.

40. The method of claim 1, wherein the monitoring of the sensor characteristics is performed with use of a sensor including a conductor cord or strip comprising a termite-gnawable material, the termite-gnawable material comprising wood.

41. The method of claim 1, wherein the monitoring of the sensor characteristics is performed with use of a sensor circuit comprising a conductor cord or strip, a signal generator, and a detector, the conductor cord comprising one or more conductors and including a termite-gnawable material.

42. The system of claim 21, wherein the at least one sensor includes a conductor cord comprising a termite-gnawable material.

43. The system of claim 21, wherein the at least one sensor comprises a conductor cord or strip, a signal generator, and a detector, the conductor cord comprising one or more conductors and including a termite-gnawable material.

44. The device of claim 32, wherein the at least one sensor comprises a conductor cord or strip comprising a termite-gnawable material.

45. The device of claim 32, wherein the at least one sensor comprises a conductor cord or strip, a signal generator, and a detector, the conductor cord comprising one or more conductors and including a termite-gnawable material.
